(19) United States
(12) Patent Application Publication
(10) Pub. No.: US 2022/0414560 A1
(43) Pub. Date: Dec. 29, 2022

(54) System and Method for Performing Environmental, Social, and Governance (ESG) Rating Across Multiple Asset Classes

(71) Applicant: Impact Cubed Limited, Saint Helier (JE)

(72) Inventors: Lawrence Robert ABELE, Saint Helier (JE); Antti Kalervo SAVILAAKSO, Chatham (GB)

(73) Assignee: Impact Cubed Limited, a Registered Private Company of the Bailiwick of JERSEY, Saint Helier (JE)

(21) Appl. No.: 17/343,945

(22) Filed: Jun. 10, 2021

(51) Int. Cl. G06Q 10/06; G06Q 50/18; G06Q 50/26; G06Q 40/04

(52) U.S. Cl. CPC G06Q 10/0635; G06Q 10/06393; G06Q 50/18; G06Q 50/26; G06Q 40/04; G06Q 10/067

(57) ABSTRACT

An Environmental, Social, and Governance (ESG) rating is provided for an entity with multiple assets. A plurality of metrics are defined. A value for each metric for each asset is obtained if available, or is set to 0. Similarly, a value for each metric for a benchmark is obtained if available, or is set to 0. For each metric and for each asset, a weight is calculated as a difference between the corresponding value of such metric for the asset and the corresponding value of such metric for the benchmark. For each metric, the weights thereof are combined to produce a composite weight across all assets. For each composite weight, a point value is assigned thereto based on a corresponding risk model. The point values are aggregated, and the aggregate is adjusted based on a perceived risk for the entity to produce the ESG rating.

### FIELD

The present disclosure relates to the field of Environmental, Social, and Governance (ESG) Rating. More particularly, the present disclosure relates to such ESG Rating of an entity for purposes of investment analysis, entity profiling, comparing the entity to other entities, and the like. Specifically, the present disclosure relates to such ESG Rating in the context of an entity that encompasses or holds multiple classes of assets.

### BACKGROUND

As is known, in the field of investments and investing, a standard practice is to use modern portfolio theory to measure risk and return and then use such measurements in deciding where to allocate capital or the like. In addition to deciding whether to invest capital or the like with an entity based on financial criteria, such as historical gains, projected gains, etc., capital may be invested based on non-financial criteria, including political criteria and social criteria, among others. For one example, an investor may decide to invest in a first entity because the first entity performs a perceived good action, and similarly may decide to divest from a second entity because an activity of the second entity is a perceived bad action. Specific examples of such perceived good and bad actions abound, and may include actions such as developing environmentally sound technologies (good, presumably), conducting business with a repressive political regime (bad, presumably), hiring with an eye toward promoting diversity (good, presumably), and donating to political causes that are deemed unpopular (bad, presumably), among other things. Note too that an investor may be required to consider non-financial criteria, based on reasons including regulatory requirements, disclosure requirements, fiduciary requirements, and the like. Similarly, an advisor to an investor may be required to consider non-financial criteria, perhaps if the investor wants to align their investments with their values.

Previously, investing based on non-financial criteria was considered irresponsible if not anti-capitalistic. Essentially, valuation of an entity such as a corporation or the like was based only on the financial performance thereof and without regard for social considerations, such as whether the entity was a ‘good citizen’, performed a ‘worthwhile function’, or otherwise conducted its business in an ‘honorable’ manner. However, investing based on non-financial criteria has become more prominent, such that the measurement of the value of an entity now commonly includes considerations of societal value present in an entity.

Today, a responsible investor recognizes that non-financial criteria should be included when determining the value of an entity, including environmental and social criteria. Accordingly, such non-financial criteria have been categorized and rated as part of an overall field known as Environmental, Social, and Governance (ESG), and investment is now regularly performed based at least in part on ESG and related considerations. Most relevant to the present disclosure, the field of ESG Rating has arisen in order to provide investors and others with ratings of entities according to ESG considerations, so that such investors and others may compare entities with each other according to ESG ratings thereof, and also so that such investors and others may decide whether an entity is in and of itself a responsible economic actor in terms of ESG considerations.

Mainly, ESG rating is performed according to specific ESG factors that have become generally accepted as being indicative of ESG considerations. Such ESG factors, while somewhat intangible, are nevertheless capable of being measured and/or quantified, and thus can be used to arrive at the aforementioned ratings for entities. Briefly, such ESG factors include environmental concerns such as whether an entity contributes to climate change, and whether the entity operates according to sustainability practices; social concerns such as whether an entity practices diversity in its hiring practice, whether the entity observes and supports human rights goals, whether the entity deals fairly with consumers, and whether the entity treats animals humanely; and governance concerns, such as whether an entity has a management structure responsive to social issues, whether the entity treats the employees thereof well, whether the executive compensation is considered excessive, especially in comparison to most employees, and whether employee compensation is considered fair in terms of issues such as gender disparity, prevalent standards of living, and the like.

Notably, investing based on ESG factors and related ratings has had considerable success, both for investors and for the entities invested thereby. For investors, ESG investing has helped to avoid potential pitfalls, such as entities that suddenly lose value after having experienced perceived social disasters, and to identify opportunities, such as entities that gain value based on perceived good actions. For the entities, ESG investing has acted as a guide to both positive and negative practices, activities, and the like that will affect value. Thus, ESG best practices for investors and entities have arisen, and ESG investment practices in particular are now a regular and accepted aspect of investing in general.

As a result, investors and others increasingly rely on ESG ratings of entities, and in particular ESG rating agencies that assess, measure and compare the ESG performance of entities. Each rating agency as may be expected develops a corresponding set of metrics and procedures, and accordingly both gathers ESG data from appropriate sources and assesses such ESG data in an effort to measure a level of ESG compliance for each of several entities. That said, an issue has arisen in that, while ESG rating agencies can compare similarly situated entities to arrive at ESG ratings therefor, such agencies cannot likewise compare disparate or dissimilar entities, and especially different classes of entities. For example, such ESG rating agencies can compare one mutual fund holding stocks as against another mutual fund holding stocks, but cannot likewise compare one mutual fund holding stocks as against a bond fund holding bonds. Similarly, an issue has also arisen in that, while ESG rating agencies can objectively rate an entity that invests in multiple similar assets within a class of such assets, such agencies cannot likewise rate an entity that invests in multiple dissimilar assets across multiple classes of such assets. For example, such ESG rating agencies can rate the aforementioned mutual fund holding stocks only, perhaps against a benchmark, but cannot likewise rate a pension plan holding both stocks and bonds.

Accordingly, a need exists for a system and method for performing ESG rating across multiple asset classes. In particular, a need exists for such a system and method where an ESG rating agency can assemble a rating for an entity that owns or otherwise holds assets from multiple asset classes, such as both stocks and bonds. Specifically, a need exists for such a system and method where common metrics are developed across the multiple assets, where a value for each metric for each asset is arrived at, and the values are weighted and combined to arrive at the rating.

### SUMMARY

A system and method are set forth for providing an Environmental, Social, and Governance (ESG) rating for an entity. The entity includes a plurality of assets, where each asset belongs to one of a plurality of classes of assets, and where each class of assets is a grouping of similar investments. The method is performed by a computing system of an ESG rater that includes a database storing data, a memory storing a plurality of actions constituting the method, and a processor accessing the data in the database and the actions in the memory and performing the actions with regard to the data to achieve the method.

A benchmark against which the entity is to be compared is selected. A plurality of metrics are defined to be of interest, where each defined metric represents an aspect of at least one of the assets and corresponds to an ESG goal. Each class of assets has a common subset of the defined metrics associated therewith, and the benchmark also has a common subset of the defined metrics associated therewith. The common subsets of defined metrics at least potentially differ from subset to subset.

A value for each defined metric for each asset of the entity is obtained from the database if such defined metric is available for such asset based on the class thereof, or else the value of such defined metric for such asset is set to 0 (zero). Similarly, a value for each defined metric for the benchmark is obtained from the database if such defined metric is available for such benchmark, or else the value of such defined metric for such benchmark is set to 0 (zero).

For each defined metric and for each asset, a weight is calculated for the defined metric for the asset as a difference between the corresponding value of such defined metric for the asset and the corresponding value of such defined metric for the benchmark. For each defined metric, the weights thereof are combined according to a predetermined compositing function to produce a composite weight for the defined metric across all of the assets of the entity. For each composite weight, a point value is assigned to the composite weight based on a corresponding risk model. The point values for all the composite weights are aggregated to arrive at an aggregated point value for the entity, and the aggregated point value is adjusted based on a perceived risk for the entity to produce the ESG rating for the entity. Thus, an entity having assets from dissimilar and seemingly incongruous classes may nevertheless be provided an ESG rating, and the provided ESG rating for the entity reflects whether the entity is a responsible ESG actor with regard to the benchmark.

### BRIEF DESCRIPTION OF THE DRAWINGS

The foregoing summary as well as the following detailed description of various embodiments of the present innovation will be better understood when read in conjunction with the appended drawings. For the purpose of illustrating the various embodiments of the innovation, there are shown in the drawings embodiments that are presently preferred. As should be understood, however, the innovation is not limited to the precise arrangements and instrumentalities shown. In the drawings:

FIG. 1 is a block diagram of an example of a computing environment within which various embodiments of the present innovation may be implemented;

FIG. 2 is a block diagram showing an ESG rating system of a rating agency that allows the rating agency to perform ESG rating of an entity with one or more assets that may span across multiple asset classes in accordance with various embodiments of the present innovation;

FIG. 3 is a flow diagram showing actions performed by the ESG rating system of FIG. 2 in the context where the entity is a single asset in accordance with various embodiments of the present innovation;

FIG. 4 is a flow diagram showing actions performed by the ESG rating system of FIG. 2 in the context where the entity is a plurality of assets in accordance with various embodiments of the present innovation;

FIG. 5 is a flow diagram showing actions performed by the ESG rating system of FIG. 2 in the context where the entity is a plurality of multi-class assets in accordance with various embodiments of the present innovation; and

FIG. 6 is a table showing an example of available metrics for a benchmark and two classes of assets, where the metrics if available would be employed in connection with the flow diagram of FIG. 5 in accordance with various embodiments of the present innovation.

### DETAILED DESCRIPTION OF PREFERRED EMBODIMENTS

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a tip” includes a plurality of tips. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this innovation belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

### Example Computing Environment

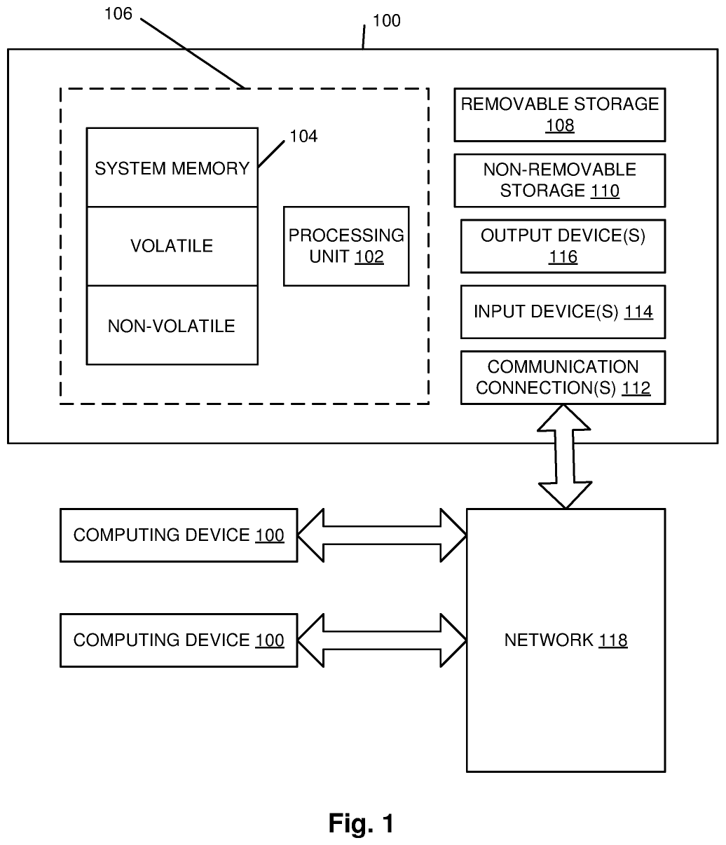

FIG. 1 is set forth herein as an exemplary computing environment in which various embodiments of the present invention may be implemented. The computing system environment is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, ‘smart’ phones, personal computers (PCs), server computers, handheld or laptop devices, multi-processor systems, microprocessor-based systems, network PCs, minicomputers, mainframe computers, embedded systems, distributed computing environments that include any of the above systems or devices, and the like.

Computer-executable instructions such as program modules executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing aspects described herein includes a computing device, such as computing device 100. In its most basic configuration, computing device 100 typically includes at least one processing unit 102 and memory 104. Depending on the exact configuration and type of computing device, memory 104 may be volatile (such as random access memory (RAM)), non-volatile (such as read-only memory (ROM), flash memory, etc.), or some combination of the two. This most basic configuration is illustrated in FIG. 1 by dashed line 106. Computing device 100 may have additional features and functionality. For example, computing device 100 may include additional storage (removable and/or non-removable) including, but not limited to, magnetic or optical disks or tape. Such additional storage is illustrated in FIG. 1 by removable storage 108 and non-removable storage 110.

Computing device 100 typically includes or is provided with a variety of computer-readable hardware media. Computer-readable media can be any available media that can be accessed by computing device 100 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 104, removable storage 108, and non-removable storage 110 are all examples of computer storage media. Computer storage media includes, but is not limited to, RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other computer-readable hardware medium which can be used to store the desired information and which can be accessed by computing device 100. Any such computer storage media may be part of computing device 100.

Computing device 100 may also contain communications connection(s) 112 that allow the device to communicate with other devices 100. Each such communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection (including VoIP), and wireless media such as acoustic, radio frequency (RF), Wi-Fi, infrared and other wireless media. The term computer-readable media as used herein includes both storage media and communication media.

Computing device 100 may also have input device(s) 114 such as keyboard, mouse, pen, voice input device, touch input device, etc. Output device(s) 116 such as a display, speakers, printer, etc. may also be included. All these devices are generally known to the relevant public and therefore need not be discussed in any detail herein except as provided.

Notably, computing device 100 may be one of a plurality of computing devices 100 inter-connected by a network 118, as is shown in FIG. 1. As may be appreciated, the network 118 may be any appropriate network, each computing device 100 may be connected thereto by way of a connection 112 in any appropriate manner, and each computing device 100 may communicate with one or more of the other computing devices 100 in the network 118 in any appropriate manner. For example, the network 118 may be a wired or wireless network within an organization or home or the like, and may include a direct or indirect coupling to an external network such as the Internet or the like. Likewise, the network 118 may be such an external network.

Particularly in the case where the network 118 is an external network, such network 118 may be a digitally based network (including VoIP) for exchanging computer data among the devices 100, may be an audio and/or video network for exchanging audio and/or video data among the devices 100, or the like. Thus, it may be that the network 118 may be a public switched telephone network for landline telephone communications, a mobile switching center for wireless telephone communications, a paging network for distributing paging information, a private multimedia network for establishing videoconferencing, or the like. Thus, it should be appreciated that one or more of the computing devices 100 that are shown to the left of the network 118 in FIG. 1 may be a mobile telephone, a landline telephone, a pager, a mobile electronic mail device, a desktop electronic mail device, a mobile electronic texting device, a desktop electronic texting device, or a combination thereof, or the like.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such a magnetic disk, an optical disk, a flash RAM drive, a locally accessible storage medium, a remotely accessible storage medium, or any other machine-readable storage medium wherein, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application-program interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as a network 118 or a distributed computing environment. Still further, aspects of the presently disclosed subject matter may be implemented in or across a plurality of processing chips or devices, and storage may similarly be effectuated across a plurality of devices in a network 118. Such devices might include personal computers, network servers, and handheld devices, for example.

### Environmental, Social, and Governance (ESG) Rating

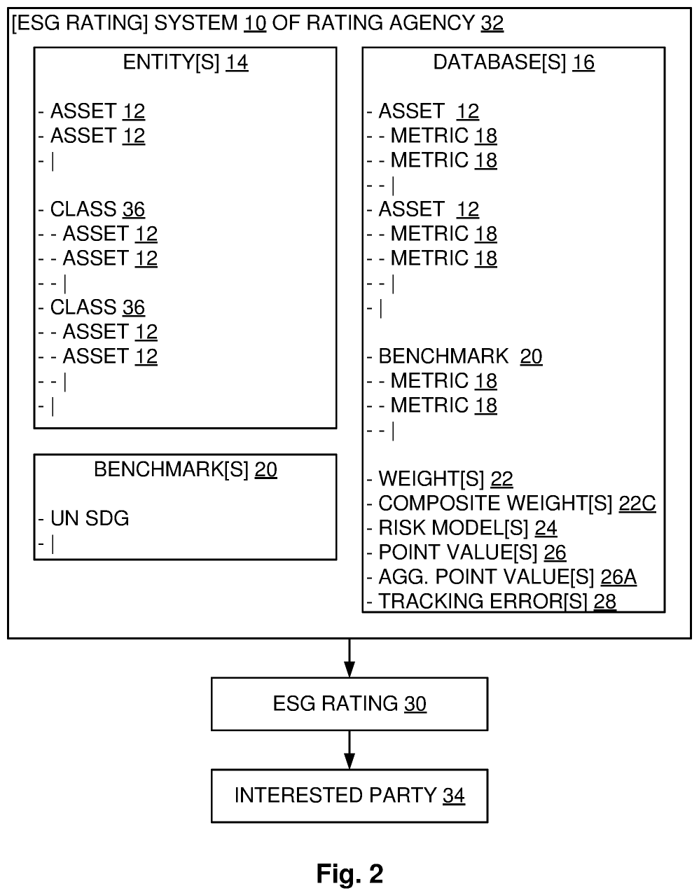

Turning now to FIG. 2, it is seen that a system 10 is provided to quantify or rate ESG for an asset 12 or a portfolio of such assets 12. With the system 10, one asset or group of assets 12 can be compared to another in order to assess the ESG impact thereof. Thus, such asset 12/group of assets 12 (hereinafter, ‘entity 14’) can be compared with another entity 14, with a benchmark 20, with a hypothetical norm, etc. Presumptively, the system 10 is instantiated on one or more of the computing devices 100 appropriately interconnected with the aid of the network 118. As such, the system 10 may include or have access to one or more databases 16 (hereinafter, ‘database 16’) as may be necessary both to acquire data, to arrive at intermediary values, and to store results. As may be appreciated, such database 16 may be any appropriately configured database without departing from the spirit and scope of the present innovation. Such database 16 and/or the information stored therein are generally known or should be apparent to the relevant public and therefore need not be set forth herein in any detail beyond that which is provided.

In assessing the ESG impact of an entity 14, the assessment is typically in comparison with something, be it another entity 14, a benchmark 20, or the like. As may be appreciated, in comparing two entities 14, the end result is a statement or rating to the effect that a first entity 14 has a relative impact as compared with the second entity 14, such as for example twice the impact, or 150 percent of the impact, etc. Similarly, in comparing an entity 14 against a benchmark 20, the end result is a statement or rating to the effect that the entity 14 has a rating with respect to the benchmark 20, where the rating can be expressed as a score, a letter grade, a plus/minus grade, etc. In the latter case, the benchmark 20 may be most any appropriate benchmark without departing from the spirit and scope of the present innovation. With respect to ESG impact, one useful and generally known benchmark 20 that has been empirically arrived at is the United Nations Sustainable Development Goals (UN SDG), which represents a set of ESG policy goals. With such UN SDG benchmark 20, for example, the system 10 measures the amount of ‘ESG’ in an entity 14 by establishing how aligned the entity 14 is with the UN SDG. More generally, the benchmark 20 may be any appropriate type of benchmark, such as for example an index, a peer group, an individual security, a book of loans, a basket of commodities, etc.

At this point, it may be useful to compare and contrast an entity 14 and an asset 12. In some instances, an entity 14 can be considered as a single asset 12, such as for example where the entity 14 is a business that operates a single generally well-defined core activity. In other instances, an entity 14 can be considered as a collection of a plurality of assets 12, such as for example where the entity 14 is a corporation that runs a number of generally well-defined businesses. In still other instances, an entity 14 can be considered as a collection of a plurality of assets 12, such as for example where the entity 14 is an investment fund that holds investment shares of each of several corporations, or that holds bonds issued by each of several governmental units, or that holds parcels of land, or that holds other individual constituents, etc. In the context of the present disclosure, an asset 12 is often akin to a security such as a listed equity, a private equity, a commoditized asset, a derivative, a loan, a bond, etc., and an entity 14 is often akin to an agglomeration of such assets 12, such as a mutual fund, a bond fund, a pension plan, a diversified corporate umbrella, etc., or even a person. All that said, an asset 12 and an entity 14 may be most any appropriate asset or entity without departing from the spirit and scope of the present innovation. Notably, in the context of the present innovation, an ESG rating may be derived for each asset 12 of an entity 14, and for the entity 14 itself, as will be set forth in more detail below.

In the system 10 of the present innovation, each asset 12, regardless of whether such asset 12 is part of an entity 14 or is the entity 14, has defined therefor a number of characteristics or metrics 18, where each metric 18 is commonly defined across a number of assets 12. Generally, each metric 18 is designed to represent an aspect of the asset 12 and in particular how such aspect of the asset 12 aligns with other assets 12 or a benchmark (the UN SDG, e.g.). Although the metrics 18 may be most any metrics 18 without departing from the spirit and scope of the present innovation, a set of metrics 18 have been arrived at empirically, where the metrics 18 in the set are well-defined and measured, are available for assets 12 from any of several known data sets, and represent ESG goals that should be strived for. Such set of metrics 18 includes but is not limited to:

Carbon Efficiency—Measures how asset 12 operations link to climate change by indicating how much greenhouse gases a company emits per unit of revenue

Waste Efficiency—Measures how much waste an asset 12 generates per unit of revenue

Water Efficiency—Measures how much water an asset 12 uses per unit of revenue

Gender Equality—Measures the gender balance of upper-level management of an asset 12, such for example board-level management and/or executive-level management

Executive Pay—Measures a ratio of compensation for upper-level management of an asset 12 as compared to average employee compensation

Board Independence—Measures how independent each individual board member of an asset 12 is with respect to the asset 12, in terms of how much of an ownership interest the member has in the asset 12

Environmental Good, Avoiding Environmental Harm, Social Good, and Avoiding Social Harm—Each is constructed similarly, based on products and/or services provided by an asset 12, perhaps based on a revenue classification system, and is somewhat subjective although erring on the side of caution; ‘Good’ activities are positively scored, while ‘Bad’ activities are negatively scored

Economic Development—Measures whether an asset 12 has a positive impact in developing economies, especially in disadvantaged and developing areas

Avoiding Water Scarcity—Measures how much water an asset 12 uses as compared against general availability of the water

Employment—Measures how much an asset 12 provides employment opportunities in particular geographic locations as compared to the unemployment rates for the geographic locations

Tax Gap—Measures the difference between the total amount of taxes owed by an asset 12 and the total amount paid, or perhaps between a statutory rate and an effective rate for the asset 12

As should be appreciated, the metrics 18 employed by the system 10 may be any appropriate metrics 18 without departing from the spirit and scope of the present innovation. As alluded to above, data representative of the metrics 18 are generally obtainable from appropriate data sources, and such data is set forth in one or more data sets stored in database 16. Such data sources and data sets may generally be any appropriate sources and sets without departing from the spirit and scope of the present innovation. For example, the metrics 18 may be aggregated from annual and quarterly filings of assets 12, and from information aggregated by various sources. Notably, many of the metrics 18 and/or constituents thereof are part of listing requirements of investment markets around the world, and are therefore widely available.

Presuming that the ESG impact of an entity 14 is assessed as against a predetermined benchmark 20, be it another entity 14, the UN SDG, or otherwise, such benchmark 20 is considered to represent ‘business as usual’, ‘the norm’, ‘the baseline’, ‘the competition’, etc. in various embodiments of the present innovation. Accordingly, how the entity 14 deviates from the benchmark 20 is of particular interest. That is to say, for each assessed metric 18 of the entity 14, how the metric 18 compares to the corresponding metric 18 of the benchmark 20 is considered. Accordingly, data representative of the corresponding metrics 18 of the benchmark 20 are set forth in one or more data sets stored in database 16, as is seen in FIG. 2.

### Case: Entity 14 is Single Asset 12

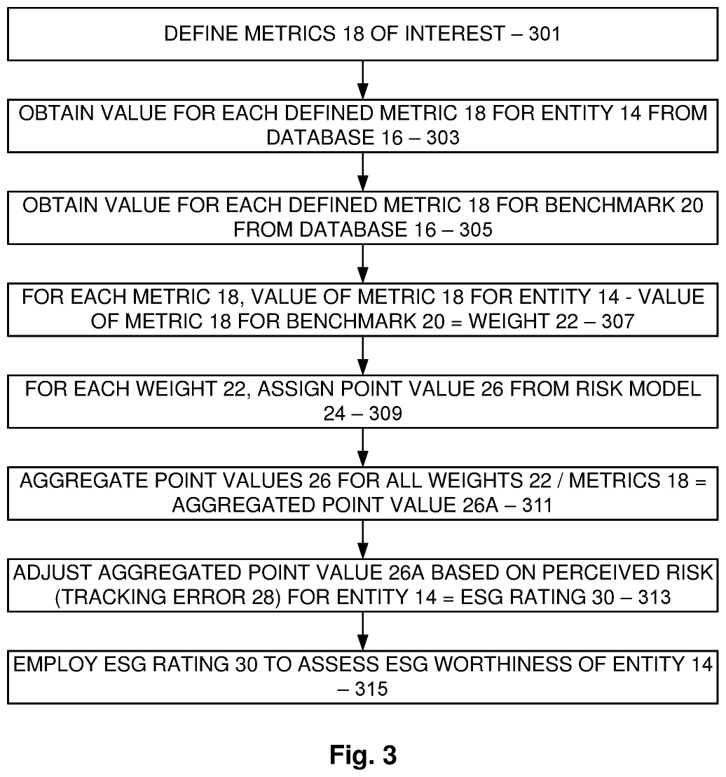

Turning now to FIG. 3, it is seen that a series of actions are performed with regard to an entity 14 to establish how each metric 18 of the entity 14 compares to the corresponding metric 18 of a benchmark 20, and more generally how the ESG impact of the entity 14 is assessed. With regard to FIG. 3, it is to be presumed that the entity 14 is a single asset 12. Preliminarily, a plurality of metrics 18 are defined to be of interest (301), the value for each defined metric 18 for the entity 14 is obtained from the database 16 (303), and the value for each defined metric 18 for the benchmark 20 is likewise obtained from the database 16 (305). Thereafter, for each metric 18, a difference is found between the corresponding value of such metric 18 for the entity 14 and the corresponding value of such metric 18 for the benchmark 20 (307), where such difference may be called a weight 22:

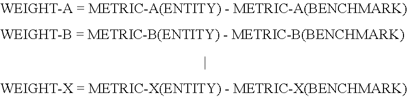

where A, B, . . . , X are employed to represent different metrics 18. Note here that each weight 22 can be positive or negative in value, where either positive or negative could be considered ‘good’, in which case the opposite would be considered ‘bad’.

Although each weight 22 is meaningful in and of itself, the weight 22 is not necessarily of a form that can be aggregated with other weights 22 in the manner set forth below. For one thing, the value of each weight 22 is likely set forth in differing units of measure. For another, the value of a first one of the weights 22 may normally be set forth in thousands of units while the value of a second one of the weights 22 may normally be set forth in tens of units, in which case the first weight 22 would likely overpower the second weight 22 and render same all but irrelevant. Accordingly, in various embodiments of the present innovation, for each weight 22, a risk model 24 is employed to assign a point value 26 to the weight 22 (309). As may be appreciated, the risk model 24 may be any appropriate risk model 24 without departing from the spirit and scope of the present innovation, and such risk model 24 may be stored in the database 16 or the like. Such risk model 24 is generally known or should be apparent to the relevant public and therefore need not be set forth herein in any detail other than that which is provided.

Generally, the risk model 24 is for each weight 22 a function that converts the weight 22 to a corresponding point value 26 in a reasoned manner:

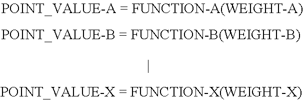

As may be appreciated, the function for each weight 22 may be linear or non-linear. In the former case, the risk model 24 may for example multiply the weight 22 by a correcting factor, perhaps in order to align the weight 22 with other weights 22. In the latter case, the risk model 24 may for example convert the weight 22 to a first point value if such weight is above a certain number, and convert the weight 22 to a second point value if such weight is below the certain number, among other things.

Once a point value 26 for each corresponding weight 22 is derived from the risk model 24 as at 309, the point values 26 for all the weights 22 and by extension all of the metrics 18 are aggregated to arrive at an aggregated point value 26A for the entity 14 (311):

AG_POINT_VALUE=AGGREGATION(POINT_VALUE-A, POINT_VALUE-B, |, POINT_VALUE-X)

As may be appreciated, such aggregation may be any appropriate aggregation without departing from the spirit and scope of the present innovation. For example, such aggregation may be a summation of the point values 26, especially if each point value 26 is without units of measure or has a common unit of measure and has been normalized to a summable value by the risk model 24. Likewise, such aggregation may be a root-mean-square or other similar compilation of the point values 26. As may be appreciated, such aggregation may be performed in any appropriate manner without departing from the spirit and scope of the present innovation.

As may be appreciated, the aggregated point value 26A for the entity 14 represents how well the entity 14 compares to the benchmark 20 in terms of ESG factors as represented by the metrics 18 employed to arrive at such aggregated point value 26A. However, the aggregated point value 26A for each of multiple entities 14 is not necessarily directly comparable as between such entities 14. In particular, and as may be understood, inasmuch as different entities 14 may act in different fields of endeavor, may have different management structures, may operate in different geographic locations, may produce different products/services, may have different employee organizational structures, etc., such different entities 14 are exposed to different risks, and accordingly such different risks have to be taken into account in order to allow for direct comparisons between such different entities 14.

In various embodiments of the present innovation, in order to allow for such direct comparisons between such different entities 14, and in order to take into account such different risks, the aggregated point value 26A for the entity 14 which was arrived at as at 311 is adjusted based on a perceived risk for the entity 14 (313) to arrive at an ESG rating 30 for the entity 14. Such perceived risk may be arrived at from any of a plurality of risk assessments without departing from the spirit and scope of the present innovation. In one embodiment, such perceived risk is expressed as a tracking error 28:

ESG RATING=AG_POINT_VALUE/TRACKING_ERROR

As seen, the adjustment as at 313 is a division of the aggregated point value 26A by the tracking error 28, although other appropriate manners of adjustment may alternately be performed as deemed necessary and/or advisable. As may be appreciated, such tracking error 28 for the entity 14 is readily available, for example from the database 16, or may be readily derived for the entity 14 based on known factors thereof, where such known factors are readily available, again for example from the database 16.

Such tracking error 28 is generally known or should be apparent to the relevant public, and therefore need not be set forth herein in any detail other than that which is provided. That said, it is to be appreciated that a tracking error 28 in general is the divergence between the price behavior of an entity 14 and the price behavior of a norm, which may be the benchmark 20 employed thus far in connection with FIG. 3 or another benchmark 20, and arises when the entity 14 works more or less effectively as expected, creating an unexpected gain or loss of financial value. Typically, a tracking error 28 is reported as the standard deviation of the difference in percentage return between a return actually received from an entity 14 and a return that would have been achieved from investing in a benchmark 20 to which the entity 14 is being compared. Since portfolio risk is often measured against a benchmark 20, a tracking error 28 is a commonly used metric to gauge how well an investment is performing. As a frame of reference, an index fund that attempts to mimic an index should theoretically have a tracking error of zero relative to such index, but more likely would have a tracking error of 1 or 2 percent or so, mainly due to factors such as diversification rules, fund fees, lending costs, etc. Most traditional active managers have tracking errors of about 4 to 7 percent or so.

At any rate, once an ESG rating 30 is arrived at for an entity 14, such ESG rating 30 may be employed in any of several manners in order to assess the ESG worthiness of the entity 14 (315). At a minimum, the ESG rating 30 represents how the entity 14 compares to the benchmark 20 in terms of ESG, whatever the benchmark 20 may be. Thus, if the benchmark 20 is another entity 14, the comparison is a direct one between such entities 14, while if the benchmark 20 is an amalgam of other entities 14, the comparison is a direct one between the entity 14 and the amalgam. Similarly, if the benchmark 20 is a hypothetical norm or a standard, such as the UN SDG, the comparison is a direct one between the entity 14 and such norm or standard.

### Case: Entity 14 is Plurality of Assets 12

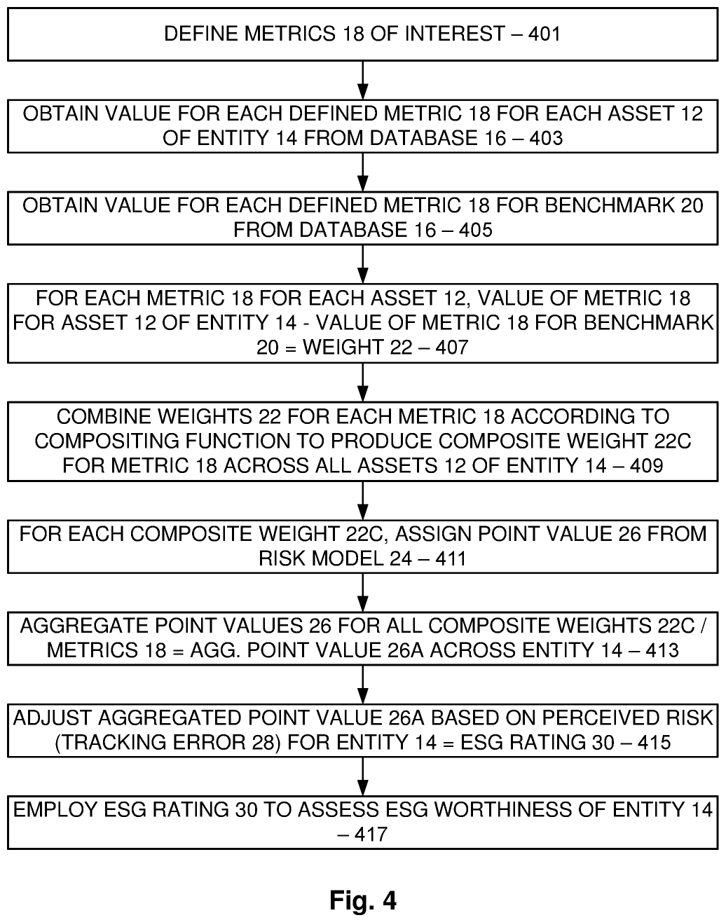

Thus far, and with regard to FIG. 3, it has been presumed that the entity 14 is a single asset 12. Turning now to FIG. 4, it is seen that the case is considered where the entity 14 is a collection of a plurality of assets 12, such as for example where the entity 14 is a mutual fund composed of multiple stocks or bonds, or a diversified corporation composed of multiple subsidiaries, among other things. As before, a series of actions are performed with regard to such entity 14 to establish how each metric 18 of the entity 14 compares to the corresponding metric 18 of a benchmark 20. Here, though, the series of actions in actuality are performed with regard to each of the plurality of assets 12 of the entity 14 to establish how the metrics 18 of the assets 12 compare to the corresponding metric 18 of the benchmark 20.

Similar to before, a plurality of metrics 18 are defined to be of interest (401), the value for each defined metric 18 for each asset 12 of the entity 14 is obtained from the database 16 (403), and the value for each defined metric 18 for the benchmark 20 is likewise obtained from the database 16 (405). Thereafter, for each metric 18 and for each asset 12, a difference is found between the corresponding value of such metric 18 for the asset 12 and the corresponding value of such metric 18 for the benchmark 20 (407), where such difference is again called a weight 22:

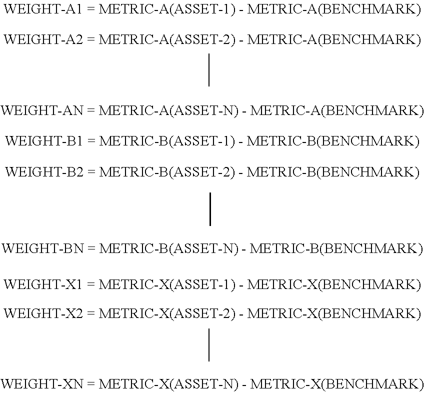

where A, B, . . . , X are employed to represent different metrics 18 and 1, 2, . . . , N are employed to represent different assets 12. As should now be understood, in the context of FIG. 4, for each metric 18, there is now a corresponding weight 22 for each asset 12. In contrast, in the context of FIG. 3, for each metric 18, there was only one corresponding weight 22 for the entity 14. As before, it can be noted here that each weight 22 for each asset 12 and for each metric 20 can be positive or negative in value, where either positive or negative could be considered ‘good’, in which case the opposite would be considered ‘bad’.

Still referring to FIG. 4, inasmuch as there are multiple weights 22 for each metric 18, where each of the multiple weights 22 corresponds to a specific asset 12 of the entity 14, and in various embodiments of the present innovation, the multiple weights 22 for each metric 18 are combined according to a predetermined compositing function to produce a composite weight 22C for the metric 18 across all of the assets 12 of the entity 14 (409):

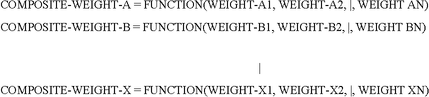

As may be appreciated, the compositing function for compositing each weight 22 of a particular metric 18 to form the composite weight 22C for such metric 18 may be any appropriate compositing function without departing from the spirit and scope of the present innovation. For example, the compositing function may produce a weighted average of all of the weights 22 of the metric 18. In such instance, and as should be understood, the weighting with regard to each asset 12 may be performed according to the percentage of value of each asset 12 within the entity 14, according to the percentage of income from each asset 12 within the entity 14, according to the percentage of gain from each asset 12 within the entity 14, etc. If indeed the weights 22 include negative values, the compositing function may take the negativeness of such negative values into consideration, or may ignore same. As should also be appreciated, the compositing function for compositing each weight 22 of a particular metric 18 may differ from metric 18 to metric 18. As may be further appreciated, in compositing each weight 22 of a particular metric 18, the compositing function may correct and/or convert each weight 22 as may be necessary in order that each weight 22 is in a form amenable to compositing.

As before, each composite weight 22C is meaningful in and of itself, but is not necessarily of a form that can be aggregated with other composite weights 22C in the manner set forth below. Again, the value of each composite weight 22C is likely set forth in differing units of measure, and differing magnitudes. Accordingly, in various embodiments of the present innovation, and similar to before, for each composite weight 22C, a risk model 24 is employed to assign a point value 26 to the composite weight 22C (411). The risk model 24 may again be any appropriate risk model 24 without departing from the spirit and scope of the present innovation, and such risk model 24 may be stored in the database 16 or the like. Such risk model 24 is generally known or should be apparent to the relevant public and therefore need not be set forth herein in any detail other than that which is provided.

Similar to before, the risk model 24 is for each composite weight 22C a converting function that converts the composite weight 22C to a corresponding point value 26 in a reasoned manner:

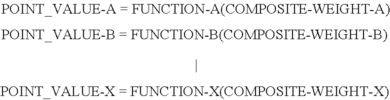

Again, the converting function for each composite weight 22C may be linear or non-linear, and may differ as between composite weights 22C.

Once a point value 26 for each corresponding composite weight 22C is derived from the risk model 24 as at 411, the point values 26 for all the composite weights 22C and by extension all of the metrics 18 are again aggregated to arrive at an aggregated point value 26A, this time across all of the assets 12 of the entity 14 (413):

AG_POINT_VALUE=AGGREGATION(POINT_VALUE-A, POINT_VALUE-B, |, POINT_VALUE-X)

Again, such aggregation may be any appropriate aggregation without departing from the spirit and scope of the present innovation. Thus, such aggregation may be a summation of the point values 26, a root-mean-square or other similar compilation of the point values 26, etc.

As before, the aggregated point value 26A for the entity 14 represents how well the entity 14 compares to the benchmark 20 in terms of ESG factors as represented by the metrics 18 employed to arrive at such aggregated point value 26A. Also as before, the aggregated point value 26A for each of multiple entities 14 is not necessarily directly comparable as between such entities 14, due to differences between such entities 14 including different risks. Accordingly, and again, in various embodiments of the present innovation, in order to allow for such direct comparisons between such different entities 14, and in order to take into account such different risks, the aggregated point value 26A for the entity 14 which was arrived at as at 413 is adjusted based on a perceived risk for the entity 14 (415) to arrive at an ESG rating 30 for the entity 14. Here too, such perceived risk may be expressed as a tracking error 28:

ESG RATING=AG_POINT_VALUE/TRACKING_ERROR

Again, the adjustment as at 415 is a division of the aggregated point value 26A by the tracking error 28, although other appropriate manners of adjustment may alternately be performed as deemed necessary and/or advisable. Such tracking error 28 for the entity 14 is readily available, for example from the database 16, or may be readily derived for the entity 14 based on known factors thereof, where such known factors are readily available, again for example from the database 16.

The use of such tracking error 28 in the context of an entity 14 having a plurality of assets 12 is especially appropriate inasmuch as tracking error has historically been employed to track how, for example, a mutual fund with multiple constituent stocks or bonds compares to a standard such as an index. Again, tracking error 28 in general is the divergence between the price behavior of an entity 14 and the price behavior of a benchmark 20, and arises when the entity 14 works more or less effectively as expected. Here too, a tracking error 28 is typically reported as the standard deviation of the difference in percentage return between a return actually received from an entity 14 and a return that would have been achieved from investing in a benchmark 20 to which the entity 14 is being compared.

As before, once an ESG rating 30 is arrived at for an entity 14, such ESG rating 30 may be employed in any of several manners in order to assess the ESG worthiness of the entity 14 (417). At a minimum, the ESG rating 30 represents how all of the assets 12 of the entity 14 compare in composite to the benchmark 20 in terms of ESG, whatever the benchmark 20 may be. Again, if the benchmark 20 is another entity 14, the comparison is a direct one between such entities 14, while if the benchmark 20 is a composite of other entities 14, the comparison is a direct one between the entity 14 and the composite. Similarly, if the benchmark 20 is a hypothetical norm or a standard, such as the UN SDG, the comparison is a direct one between the entity 14 and such norm or standard.

### Case: Entity 14 is Plurality of Multi-Class Assets 12

It is to be appreciated that most any investment vehicle can be classified into a particular class 36 of asset 12. Such classes are generally known or should be apparent to the relevant public, and need not be defined in detail here other than that which is set forth. Briefly, an asset class 36 is a grouping of investments that exhibit similar characteristics and are subject to similar legal treatment. Individual instruments within an asset class 36 may be expected to behave similarly to one another in the marketplace, at least generally. Classic examples of asset classes 36 include: equities such as stocks, fixed income instruments such as bonds, cash and cash equivalents, real estate, commodities, futures, and financial derivatives, among others. Notably, one asset class 36 may be differentiated from another based on the lack of correlation therebetween. Also notably, one reason for defining an asset class 36 is to take advantage of such differentiation, especially when building a diversified portfolio for an investor or the like.

With regard to ESG rating systems and methods, it is to be understood that an important limitation to such systems and methods has heretofore been that an entity 14 having multiple assets 12 could not be ESG rated if the multiple assets 12 included assets 12 from multiple classes 36. Put more simply, until the present innovation, ESG rating could only be performed on multiple assets 12 of an entity 14 if the multiple assets 12 were of the same class 36. Reasons for such a limitation are many and varied but generally involve the aforementioned differentiation and resulting dissimilarity between such classes 36. More specifically, aggregating information across multiple classes 36 of assets 12 was not done or even considered to be possible until the system and method of the present innovation.

However, in various embodiments of the present innovation, inasmuch as the system 10 relies on defined metrics 18 in order to ascertain ESG ratings 30, and inasmuch as the defined metrics 18 may be applied to any class 36 of asset 12, the aforementioned dissimilarities between classes 36 are only minimally problematic. Mainly, it is to be appreciated that some additional care may be necessary in applying the same metrics 18 across such dissimilar classes 36, as will be set forth in more detail below.

Note here that examples of entities 14 having multiple assets 12 including assets 12 from multiple classes 36 are many and varied, as should be appreciated by the relevant public. Particular examples of such a multi-class entity 14 include a pension plan and a private or charitable foundation, among others. As may be appreciated, in the former case, a pension plan is a retirement plan or the like that requires an employer or the like to make contributions to a pool of funds set aside for the future benefit of a plurality of employees or the like, where the pool of funds is invested on behalf of the employees and earnings on the investments generate income to the employees upon retirement. As may also be appreciated, in the latter case, a foundation is a nonprofit organization that is usually created by one or more primary donations of funds from an individual or business, where the donated funds are managed to generate income which is then regularly disbursed to desired endeavors which are usually charitable or at least in the public good. More generally, a multi-class entity 14 may encompass most any portfolio that has multiple assets 12 including assets 12 from multiple classes 36 without departing from the spirit and scope of the present innovation.

In any case, in such a multi-class entity 14, the funds thereof are typically substantial and are therefore normally invested in a diversified manner across a broad spectrum of assets 12, including assets 12 from multiple classes 36. Importantly, as with other entities 14, a multi-class entity 14 such as a pension plan, a foundation, or the like can be called upon to show that such multi-class entity 14 is a ‘good’ ESG actor, or is a responsible ESG citizen, etc. Also, such multi-class entity 14 can be called upon to show that such entity 14 exceeds a benchmark 20 such as the UN SDG benchmark or the like, and/or can be compared to another entity 14 in terms of ESG factors.

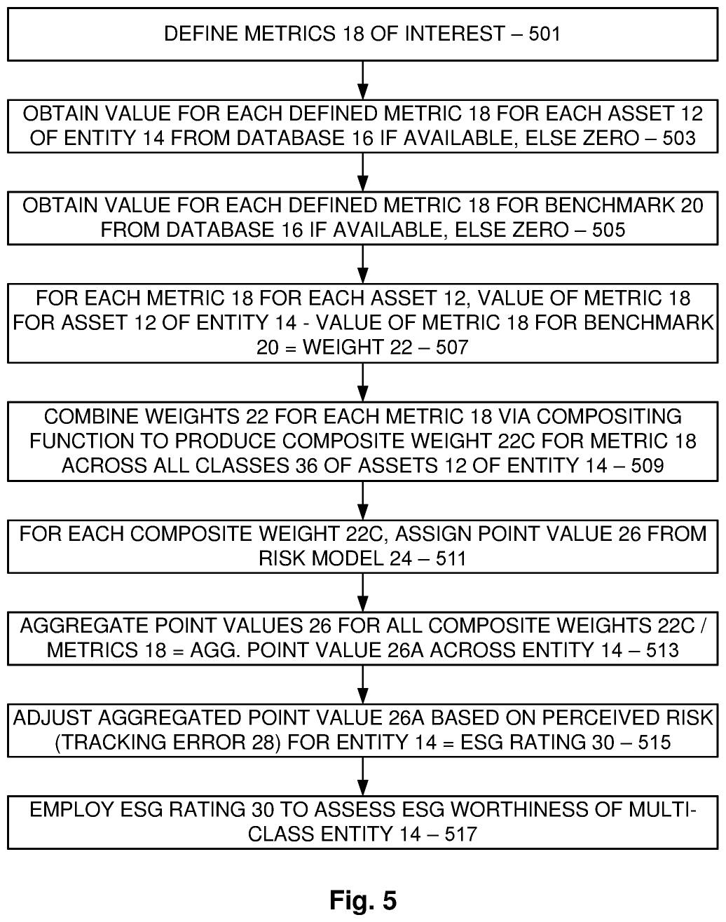

Accordingly, and in various embodiments of the present innovation, and turning now to FIG. 5, it is to be appreciated that in order to apply the same metrics 18 across dissimilar classes 36 of assets 12, it may be necessary and/or advisable to take into consideration for any particular asset 12 the class 36 thereof when performing actions akin to the actions of FIG. 4. Such a consideration of class 36 need not necessarily occur in all cases, especially if a particular metric 18 is irrelevant to a class 36 and therefore is measured substantially the same regardless of such class 36.

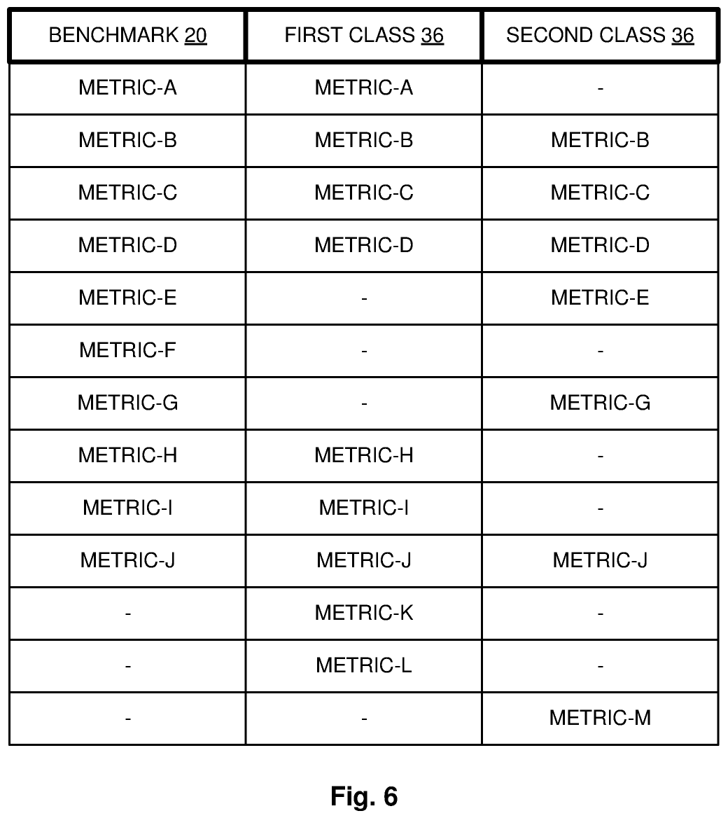

Significantly, applying the same metrics 18 across dissimilar classes 36 of assets 12 was not perceptually achievable for the reason that different asset classes 36 can be expected to have different subsets of metrics 18 associated therewith. Reasons for such differing subsets of metrics 18 are many and varied, but generally relate to the fact that some metrics 18 are not typically compiled for some classes 36 of assets 12, and also that some metrics 18 do not rationally relate to some classes of assets 12, among other things. Moreover, different benchmarks 20 can have different subsets of metrics 18 associated therewith, too, depending on how each benchmark 20 is defined. Thus, and referring now to FIG. 6, it can for example be the case that a particular benchmark 20 has metrics 18 associated therewith that include metrics A through J inclusive, while a first particular class 36 of assets 12 has metrics associated therewith that include metrics A through D inclusive and metrics H through L inclusive, and a second particular class 36 of assets 12 has metrics associated therewith that include metrics B through E inclusive and metrics G, J, and M.

Referring again to FIG. 5, in the situation where an entity 14 has multiple classes 36 of assets 12, and as before, a plurality of metrics 18 are defined to be of interest (501), and the value for each defined metric 18 for each asset 12 of the entity 14 is obtained from the database 16, if such metric 18 is available for the asset 12 based on the class 36 thereof (503). Thus, in the example of FIG. 6, for an asset 12 of the first class 36, for METRIC-A, the value thereof should be defined and present in the database 16 and thus obtained therefrom as at 503. In contradistinction, for an asset 12 of the second class 36, for METRIC-F, the value thereof should not be defined and present in the database 16 and thus cannot be obtained therefrom as at 503. Importantly, in various embodiments of the present innovation, in the latter case where the value of a metric 18 for an asset 12 is not defined and present in the database 16 because such metric 18 is not associated with the class 36 of such asset 12, the value of such metric 18 for such asset 12 is set to 0 (zero).

The value for each defined metric 18 for the benchmark 20 is likewise obtained from the database 16, if such metric 18 is available for the benchmark 20 (505). Thus, in the example of FIG. 6, for the benchmark 20, for METRIC-H, the value thereof should be defined and present in the database 16 and thus obtained therefrom as at 505. In contradistinction, for the benchmark 20, for METRIC-L, the value thereof should not be defined and present in the database 16 and thus cannot be obtained therefrom as at 505. Importantly, in various embodiments of the present innovation, and similar to before, in the latter case where the value of a metric 18 for a benchmark 20 is not defined and present in the database 16 because such metric 18 is not associated with such benchmark 20, the value of such metric 18 for such benchmark 20 is set to 0 (zero).

Thereafter, for each metric 18 and for each asset 12, a difference is found between the corresponding value of such metric 18 for the asset 12 and the corresponding value of such metric 18 for the benchmark 20 (507), where such difference is again called a weight 22:

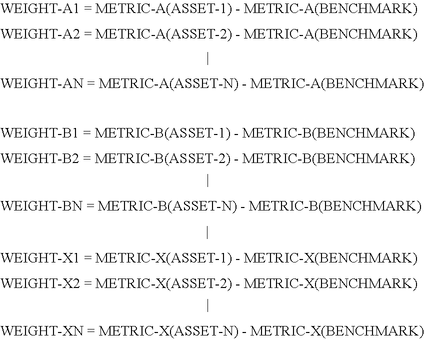

where A, B, . . . , X are employed to represent different metrics 18, and where 1, 2, . . . , N are employed to represent different assets 12. In the scenario of FIG. 5, and as with the scenario of FIG. 4, for each metric 18, there is now a corresponding weight 22 for each asset 12, whatever the class 36 of the asset 12 may be. As before, each weight 22 for each asset 12 and for each metric 20 can be positive or negative in value.

Note here that in the instance where a particular metric 18 has not been defined for the class 36 of a particular asset 12 because such metric 18 is not associated with such class 36 of such asset 12, and the value of such metric 18 for such asset 12 has been set to 0 (zero) as at 503, the weight 22 derived from such metric 18 for such asset 12 is:

WEIGHT=0−METRIC(BENCHMARK)=−METRIC(BENCHMARK)

Note too that in the instance where a particular metric 18 has not been defined for a particular benchmark 20 because such metric 18 is not associated with such benchmark 20, and the value of such metric 18 for such benchmark 20 has been set to 0 (zero) as at 505, the weight 22 derived from such metric 18 is for such asset 12 is:

WEIGHT=METRIC(ASSET)−0=METRIC(ASSET)

Note finally that in the instance where a particular metric 18 has not been defined for the class 36 of a particular asset 12 because such metric 18 is not associated with such class 36 of such asset 12, and the value of such metric 18 for such asset 12 has been set to 0 (zero) as at 503, and also where such metric 18 has not been defined for a particular benchmark 20 because such metric 18 is not associated with such benchmark 20, and the value of such metric 18 for such benchmark 20 has been set to 0 (zero) as at 505, the weight 22 derived from such metric 18 for such asset 12 and such benchmark 20 is:

WEIGHT=0−0=0

In any of these instances, it has been found that by the expedient of setting an undefined metric 18 to (0) zero, good and useful results for weights 22 are derived despite the fact that an associated metric 18 is undefined. More importantly, by such expedient, the derived weights 22 can be employed in the manner set forth below to achieve good and useful results, and an entity 14 having assets 12 from dissimilar and seemingly incongruous classes 36 may nevertheless be assigned an ESG rating 30 with good and useful results.

In various embodiments of the present innovation, it may be the case that the benchmark 20 in actuality can define the metric 18 differently for each class 36 of asset 12. If so, the value for each defined metric 18 for each class 36 of asset 12 for the benchmark 20 would be obtained from the database 16 as at 505. Thereafter, for each metric 18 and for each asset 12, the corresponding weight would be the difference between the corresponding value of such metric 18 for the asset 12 and the corresponding value of such metric 18 for the class 36 of the asset 12 for the benchmark 20, as at 507.

Still referring to FIG. 5, inasmuch as there are multiple weights 22 for each metric 18, where each of the multiple weights 22 corresponds to a specific asset 12 of the entity 14, and in various embodiments of the present innovation, the multiple weights 22 for each metric 18 are combined according to a predetermined compositing function to produce a composite weight 22C for the metric 18 across all of the assets 12 of the entity 14, without regard for the class 36 of each asset 12 (509). That is to say, even though different weights 22 for a particular metric 18 may correspond to different classes 36 of assets 12, the predetermined compositing function in producing the composite weight 22C need not necessarily take into consideration with regard to each constituent weight 22 thereof the class 36 corresponding to the weight 22:

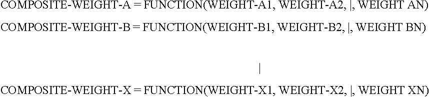

That said, the predetermined compositing function may nevertheless take into consideration with regard to each constituent weight 22 the class 36 corresponding to the weight 22, if deemed necessary and or appropriate, and in any appropriate manner without departing from the spirit and scope of the present innovation. For example, for a particular weight 22, it may be that the weight 22 is scaled an appropriate scaling factor depending on the class 36 corresponding thereto, or may be shifted an appropriate shifting factor depending on such class 36. Such taking into consideration is known or should be apparent to the relevant public and therefore need not be set forth herein in any detail other than that which is set forth.

As before, the compositing function for compositing each weight 22 of a particular metric 18 to form the composite weight 22C for such metric 18 may be any appropriate compositing function without departing from the spirit and scope of the present innovation. For example, and again, the compositing function may produce a weighted average of each weight 22 of the metric 18. Here, if the class 36 corresponding to each weight 22 is taken into consideration, the weighted average may take place thereafter. As before, the compositing function in compositing each weight 22 of a particular metric 18 may differ from metric 18 to metric 18, and the compositing function may otherwise correct and/or convert each weight 22 as may be necessary in order that each weight 22 is in a form amenable to compositing.

In the scenario of FIG. 5, once each composite weight 22C has been compiled from weights 22 across multiple assets 12, where each asset 12 may belong to one of multiple classes 36 of assets 12, the composite weight 22C does not correspond to any particular class 36 of any particular asset 12. Put more simply, once a composite weight 22C has been compiled, the classes 36 of the assets 12 that were employed to compile such composite weight 22C are believed to be no longer relevant.

Accordingly, once each composite weight 22C has been compiled in the context of FIG. 5 and as at 509, the remaining steps correspond to the remaining steps in the context of FIG. 4 and as at 409. Thus, and as seen in FIG. 5, in various embodiments of the present innovation, and similar to before, for each composite weight 22C, a risk model 24 is employed to assign a point value 26 to the composite weight 22C (511). As before, the risk model 24 is for each composite weight 22C a converting function that converts the composite weight 22C to a corresponding point value 26 in a reasoned manner:

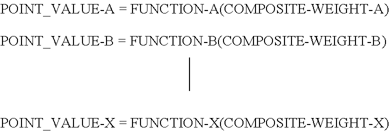

Again, the converting function for each composite weight 22C may be linear or non-linear, and may differ as between composite weights 22C. Note here that although classes 36 of assets 12 are not believed to be relevant after 509, such classes 36 may nevertheless be taken into consideration with regard to each risk model 24 and the converting function thereof as may be deemed necessary and/or appropriate without departing from the spirit and scope of the present innovation.

To continue, and again, once a point value 26 for each corresponding composite weight 22C is derived from the risk model 24 as at 511, the point values 26 for all the composite weights 22C and by extension all of the metrics 18 are again aggregated to arrive at an aggregated point value 26A, this time across all of the classes 36 of all of the assets 12 of the entity 14 (513):

AG_POINT_VALUE=AGGREGATION(POINT_VALUE-A, POINT_VALUE-B, |, POINT_VALUE-X)

Again, such aggregation may be any appropriate aggregation without departing from the spirit and scope of the present innovation. Thus, such aggregation may be a summation of the point values 26, a root-mean-square or other similar compilation of the point values 26, etc. Here too, although classes 36 of assets 12 are not believed to be relevant to such aggregation, such classes 36 may nevertheless be employed to inform the aggregation as may be deemed necessary and/or appropriate without departing from the spirit and scope of the present innovation.

As before, the aggregated point value 26A for the entity 14 represents how well the entity 14 having the multiple classes 36 of assets 12 compares to the benchmark 20 in terms of ESG factors as represented by the metrics 18 employed to arrive at such aggregated point value 26A. Also as before, the aggregated point value 26A for each of multiple entities 14 is not necessarily directly comparable as between such entities 14, due to differences between such entities 14 including different risks. Accordingly, and again, in various embodiments of the present innovation, in order to allow for such direct comparisons between such different entities 14, and in order to take into account such different risks, the aggregated point value 26A for the entity 14 which was arrived at as at 513 is adjusted based on a perceived risk for the entity 14 (515) to arrive at an ESG rating 30 for the entity 14. Here too, such perceived risk may be expressed as a tracking error 28:

ESG RATING=AG_POINT_VALUE/TRACKING_ERROR

Again, the adjustment as at 515 is a division of the aggregated point value 26A by the tracking error 28, although other appropriate manners of adjustment may be performed as deemed necessary and/or advisable. Such tracking error 28 for the entity 14 is readily available, for example from the database 16, or may be readily derived for the entity 14 based on known factors thereof, where such known factors are readily available, again for example from the database 16. Here too, although classes 36 of assets 12 are not believed to be relevant to the tracking error 28, such classes 36 may nevertheless be taken into consideration as may be deemed necessary and/or appropriate without departing from the spirit and scope of the present innovation.

As before, once an ESG rating 30 is arrived at for an entity 14 having multiple classes 36 of assets 12, such ESG rating 30 may be employed in any of several manners in order to assess the ESG worthiness of the multi-class entity 14 (517). At a minimum, the ESG rating 30 represents how all of the assets 12 of the entity 14 compare in composite to the benchmark 20 in terms of ESG, whatever the benchmark 20 may be. Again, if the benchmark 20 is another entity 14, the comparison is a direct one between such entities 14, while if the benchmark 20 is a composite of other entities 14, the comparison is a direct one between the entity 14 and the composite. Similarly, if the benchmark 20 is a hypothetical norm or a standard, such as the UN SDG, the comparison is a direct one between the entity 14 and such norm or standard. Notably, the ESG rating 30 as at 517 allows entities 14 to be compared in terms of ESG regardless of whether each entity 14 is a single asset 12, a conglomerate of multiple assets 12 of the same class 36, a conglomerate of multiple classes 36 of assets 12, or the like.

### Rating Agency

Generally, the ESG rating 30 for an entity 14 may be produced by a rating agency 32 (FIG. 2) according to the system 10 and then employed by such rating agency 32 in a manner that is generally known or should be apparent to the relevant public. Accordingly, such rating agency 32 may for example sell or otherwise provide such ESG rating 30 for the entity 14 to an interested party 34 who is interested in assessing the ESG aspect of the entity 14. Based thereon, the interested party 34 may then decide whether to purchase and/or sell an ownership interest in the entity 14, whether to enter into and/or continue business with the entity 14, whether to certify the entity 14 as meeting an ESG standard such as a benchmark 20, etc. Likewise, such rating agency 32 may for example sell or otherwise provide such ESG rating 30 for the entity 14 to the entity 14 itself. Based thereon, the entity 14 may then decide whether such ESG rating 30 is acceptable or needs improving, and if so, how. In this regard, the ESG rating 30 as provided may be broken down by the rating agency 32 to show how the entity 14 compares to the benchmark 20 in terms of each assessed metric 18, or how the entity 14 compares to another entity 14 in terms of each assessed metric 18, among other things.

Notably, many public and private entities 14 are now being evaluated and rated based on ESG performance by rating agencies 32. With ESG ratings 30 provided thereby and in accordance with various embodiments of the present innovation, the entities 14 and interested parties 34 such as individual and institutional investors, asset managers, financial advisors and institutions, and the like can employ such ratings 30 to assess, measure, and otherwise evaluate ESG performance over time and as compared to similarly peers or even dissimilarly situated third parties. Although not necessarily dispositive, ESG ratings 30 and evaluations at least inform investment decisions, and otherwise lead to engagement on ESG matters. Additionally, an entity 14 having an ESG rating 30 that is considered ‘good’ may employ such ‘good’ rating 30 to show investors in particular and the world in general that such entity 14 is a ‘good’ ESG investment, a ‘good’ ESG citizen, or the like. From at least a marketing and public relations perspective, and as should be understood, such ‘good’ rating 30 can be especially valuable.

### Conclusion

The programming believed necessary to effectuate the processes performed by the system 10 in connection with the various embodiments of the present innovation is relatively straight-forward and should be apparent to the relevant programming public based on the present disclosure. Accordingly, such programming is not attached hereto. Any particular programming, then, may be employed to effectuate the various embodiments of the present innovation without departing from the spirit and scope thereof.

In the present innovation, a system 10 and method are set forth for producing an ESG rating 30 across multiple classes 36 of assets 12 of an entity 14. An ESG rating agency 32 can thus assemble a rating 30 for an entity 14 that owns or otherwise holds assets from multiple asset classes 36, such as both stocks and bonds. The ESG rating 30 for an entity 14 is based on metrics 18 that are variously defined across the multiple assets 12, where a value for each metric 18 for each asset 12 is arrived at, and the values are weighted and combined to arrive at the rating 30.

It should be appreciated that changes could be made to the embodiments described above without departing from the innovative concepts thereof. For example, although the present innovation is set forth primarily in terms of assets 12 and entities 14 that are financial and/or corporate in nature, such assets 12 and entities 14 can be of alternate forms. Likewise, although the present innovation is set forth primarily in terms of specific kinds of functions being employed with regard to the weights 22 and metrics 18, other kinds of functions can also be employed. Moreover, although the present innovation is set forth primarily in terms of ESG rating, such innovation may also be practiced in connection with any other appropriate type of rating, perhaps with suitable modification. It should be understood, therefore, that this innovation is not limited to the particular embodiments disclosed, but it is intended to cover modifications within the spirit and scope of the present innovation as defined by the appended claims.

1. A method for providing an Environmental, Social, and Governance (ESG) rating for an entity, the entity including a plurality of assets, each asset belonging to one of a plurality of classes of assets, each class of assets being a grouping of similar investments, the method being performed by a computing system of an ESG rater, the computing system including a database storing data, a memory storing a plurality of actions constituting the method, and a processor accessing the data in the database and the actions in the memory and performing the actions with regard to the data to achieve the method, such method comprising:
selecting a benchmark against which the entity is to be compared;
defining a plurality of metrics to be of interest, each defined metric representing an aspect of at least one of the assets and corresponding to an ESG goal, each class of assets having a common subset of the defined metrics associated therewith, the benchmark also having a common subset of the defined metrics associated therewith, the common subsets of defined metrics at least potentially differing from subset to subset;
obtaining a value for each defined metric for each asset of the entity from the database if such defined metric is available for such asset based on the class thereof, or else setting the value of such defined metric for such asset to 0 (zero);
obtaining a value for each defined metric for the benchmark from the database if such defined metric is available for such benchmark, or else setting the value of such defined metric for such benchmark to 0 (zero);
for each defined metric and for each asset, calculating a weight for the defined metric for the asset as a difference between the corresponding value of such defined metric for the asset and the corresponding value of such defined metric for the benchmark;
for each defined metric, combining the weights thereof according to a predetermined compositing function to produce a composite weight for the defined metric across all of the assets of the entity;
for each composite weight, assigning a point value to the composite weight based on a corresponding risk model;
aggregating the point values for all the composite weights to arrive at an aggregated point value for the entity; and
adjusting the aggregated point value based on a perceived risk for the entity to produce the ESG rating for the entity,
whereby an entity having assets from dissimilar and seemingly incongruous classes may nevertheless be provided an ESG rating, and whereby the provided ESG rating for the entity reflects whether the entity is a responsible ESG actor with regard to the benchmark.

2. The method of claim 1 wherein the classes include equities, fixed income instruments, real estate, commodities, futures, and financial derivatives.

3. The method of claim 1 wherein the metrics are selected from a group including carbon efficiency, waste efficiency, and water efficiency.

4. The method of claim 1 wherein the benchmark is a predefined set of metrics representative of one of another entity, a set of policy goals, and an index.

5. The method of claim 1 wherein the calculated weight for the defined metric for each asset can be positive or negative in value.

6. The method of claim 1 wherein the value of a particular defined metric for a particular asset is set to 0 (zero) since such particular defined metric is not available for such particular asset based on the class thereof, and wherein the value of the corresponding calculated weight is the corresponding value of the particular defined metric for the benchmark.

7. The method of claim 1 wherein the value of a particular defined metric for a particular asset is not set to 0 (zero) since such particular defined metric is available for such particular asset based on the class thereof, wherein the value of the particular defined metric for the benchmark is set to 0 (zero) since such particular defined metric is not available for such benchmark, and wherein the value of the corresponding calculated weight is the value of the particular defined metric for the particular asset.

8. The method of claim 1 wherein the benchmark defines a particular metric differently for each of several classes of asset, wherein the value for the particular metric for each class of asset is obtained for the benchmark from the database, and wherein, for the particular metric and for each asset, the corresponding weight is a difference between the corresponding value of such particular metric 18 for the asset and the corresponding value of such particular metric for the class of the asset for the benchmark.

9. The method of claim 1 wherein the compositing function calculates a weighted average of the weights of the defined metric.

10. The method of claim 1 wherein the compositing function takes into consideration with regard to each weight the class corresponding to the weight, by at least one of scaling the weight based on the class and shifting the weight based on the class.

11. The method of claim 1 wherein the risk model for each composite weight is a converting function that converts the composite weight to the corresponding point value by at least one of multiply the composite weight by a correcting factor, converting the composite weight to a first point value if such composite weight is above a predefined value, and converting the composite weight to a second point value if such composite weight is below a predefined value.

12. The method of claim 1 wherein the aggregation of the point values is one of a summation of the point values and a root-mean-square of the point values.

13. The method of claim 1 wherein adjusting the aggregated point value to produce the ESG rating for the entity comprises: obtaining a tracking error associated with the entity from the database, and dividing the aggregated point value by the obtained tracking error, the obtained tracking error of the entity representing a divergence between a behavior of the entity and a norm to which the entity is compared.

14. The method of claim 1 wherein each of multiple entities is exposed to differing risks, and wherein adjusting the aggregated point value to produce the ESG rating for the entity comprises accounting for the differing risk to which the entity is exposed so as to allow for direct comparisons between the multiple entities.

15. The method of claim 1 further comprising employing the produced ESG rating of the entity to assess an ESG worthiness of the entity, by comparing the entity to another entity in terms of such ESG worthiness.

16. The method of claim 1 further comprising employing the produced ESG rating of the entity to assess an ESG worthiness of the entity, by comparing the entity to a norm in terms of such ESG worthiness.

17. The method of claim 1 further comprising the ESG rater providing the produced ESG rating for the entity to an interested party in exchange for value, the interested party being interested in assessing an ESG worthiness of the entity, whereby the interested party may then take a financial action with respect to the entity.

18. The method of claim 1 further comprising the ESG rater providing the produced ESG rating for the entity to such entity in exchange for value, the entity party being interested in self-assessing an ESG worthiness thereof, whereby the entity may then take actions to improve such ESG worthiness.

19. The method of claim 1 further comprising the ESG rater providing the produced ESG rating for the entity to such entity in exchange for value, the entity party being interested in promoting an ESG worthiness thereof, whereby the entity may then publicize such ESG worthiness.
